(19) United States
(12) Patent Application Publication
(10) Pub. No.: US 2009/0303196 A1
(43) Pub. Date: Dec. 10, 2009

(54) MATRIX TOUCH PANEL DEVICE

(75) Inventor: Yoshihisa Furukawa, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo ,Meguro-ku (JP)

(21) Appl. No.: 12/373,612

(22) PCT Filed: Aug. 31, 2006
(86) PCT No.: PCT/JP2006/317210

§ 371 Date: Jan. 29, 2009

(51) Int. Cl. G06F 3/041

(52) U.S. Cl. 345/173

(57) ABSTRACT

A matrix touch panel device includes input resistive films formed on a first substrate, and output resistive films formed on a second substrate placed face to face with the first substrate and intersecting with the input resistive films in a matrix with a gap therebetween, and by detecting whether any of the input resistive films and any of the output resistive films are in contact at a crossing of the input and output resistive films, detects that the first substrate is pressed against the second substrate at the crossing. The matrix touch panel device includes a voltage applying unit that applies voltage for detecting contact to each input resistive film, a voltage acquiring unit that acquires an output voltage value from each output resistive film, and a determining unit that, for each crossing, based on the acquired output voltage value, determines whether the output is attributed to a contact state.

### TECHNICAL FIELD

The present invention relates to a matrix touch panel device that detects a pressed position thereon.

### BACKGROUND ART

As is known in the art, matrix touch panel devices having the foregoing characteristic detect whether an input resistive film and an output resistive film are in contact with each other at respective crossings of the input and output resistive films, by comparing an output voltage and a reference voltage at each crossing to detect an output, and detect that a particular crossing is pressed, in other words, detect a pressed position (for example, refer to Patent Document 1). Such a matrix touch panel device, for example, is used by being placed on a display screen of various types of display devices. This is called a touch panel integrated type display device. The touch panel integrated type display device, based on the detection of a pressed position thereon, changes an image on the display screen and outputs sound, for example.

[Patent Document 1]International Publication No. WO 05/091104

### DISCLOSURE OF THE INVENTION

### Problems to be Solved

However, in the matrix touch panel device of related art, whenever output ON is detected at a crossing, it is always considered that the crossing is pressed, and consideration is not given to the fact that output ON may be detected, even if the crossing is not actually pressed. An example in which output ON is detected although a crossing in question is not actually pressed will now be described. As shown in FIG. 7, when three crossings Pb, Pc, and Pd are pressed at the same time, and each of the three crossings Pb, Pc, and Pb is in the contact state, an output alternative path (Pa-Pb-Pd-Pc-Pa) that allows the remaining crossing Pa to output (false output) is formed. This is because the three crossings Pb, Pc, and PD that are actually pressed are at three points orthogonal to one another, in other words, positioned at three points among the four crossings Pa to Pd, that are crossings of two input resistive films Ri1 and Ri2 and two output resistive films Ro1 and Ro2. In this case, a voltage is output at the crossing Pa although the voltage value is lower than that when actually being pressed (contact voltage value), and if the output voltage is higher than a reference voltage value, output ON is detected thereat. Accordingly, the crossing Pa that is not actually pressed is also detected as if being pressed. This is hereinafter referred to as a “ghost phenomenon”.

The ghost phenomenon will now be described by giving a specific example of a problem with a device to which the matrix touch panel integrated type display device is applied. FIG. 8A shows a touch panel integrated type display device formed as a keyboard of an electronic instrument. Here, keys that respectively correspond to “D”, “D#”, and “F” are pressed at the same time. A chord of “D, D#, and F” is supposed to output as a consequence. However, as shown in FIG. 8B, because the locations that are actually pressed are at three points orthogonal to one another as in the above-described example, the ghost phenomenon occurs. Accordingly, a portion that corresponds to “F#” key is also detected as if being pressed. In other words, a chord “D, D#, F, and F#” is output from a speaker.

Another example of the ghost phenomenon will be described. FIG. 9A shows a touch panel integrated type display device formed as a controller of the above-described electronic instrument. Here, a portion that corresponds to a volume control knob is pressed and a portion that corresponds to a tone control knob is also pressed (slid), so as to minutely move the tone control knob in a vertical direction. The tone control knob is supposed to minutely move in a vertical direction on the display screen (the tone also changes minutely) as a consequence. However, as shown in FIG. 9B, the portion that corresponds to the volume control knob is pressed across a plurality of crossings (five output resistive films Ro1 to Ro5) in the matrix touch panel device. Accordingly, if any one of the five crossings Pa to Pe of the input resistive film Ri1 that corresponds to the portion of the tone control knob and the five output resistive films Ro1 to Ro5 is pressed, the ghost phenomenon occurs in which it is detected as if all the five crossings Pa to Pe are pressed. In other words, the tone control knob is fixed (clamped) in the region of the output resistive films Ro1 to Ro5, and does not move minutely in a vertical direction (the tone does not change either). This is particularly referred to as a “clamping phenomenon”, that is one type of the ghost phenomena.

The matrix touch panel device in Patent Document 1 also has the following problem. As shown in FIG. 2B in Patent Document 1, an output terminal of each output resistive film is grounded, except when the output resistive film receives an output. Accordingly, as shown in FIG. 10 of the present invention, even if the crossing Pa at which an output is detected is actually being pressed (in a contact state), at the output resistive film Ro1 that forms the crossing Pa, if an intermediate crossing Pb interposed between the crossing Pa and the output terminal is in a contact state, and if an intermediate crossing Pc that is a crossing of the input resistive film Ri1 that forms the intermediate crossing Pb and the other output resistive film Ro2 is also in a contact state, the output terminal of the output resistive film Ro2 is grounded except while receiving an output. Accordingly, the output voltage value from the output resistive film Ro1 whose output is to be received will be reduced. If the intermediate crossings Pb and Pc are the only set, they can be detected as being in contact if the output voltage value is equal to or more than the reference voltage value, even if the output voltage value is lowered. However, if a plurality of sets of points positioned as the intermediate crossings Pb and Pc are in a contact state, and if the output voltage value becomes lower than the reference voltage value, even if the crossing Pa is actually pressed, it is determined that the output is not attributed to a contact state. In other words, in the output resistive films Ro1 and Ro2 that form the intermediate crossings Pb and Pc, the contact state (pressing force) is not detected at each crossing (such as the crossing Pa) placed farther from the output terminal than the intermediate crossings Pb and Pc. In other words, the output resistive films Ro1 and Ro2 constitute a “dead zone”. This is referred to as a “dead zone phenomenon”.

The dead zone phenomenon will now be described by giving a specific example of a problem with a device embodied as the matrix touch panel integrated type display device. FIG. 11A shows a touch panel integrated type display device formed as a controller of the above-described electronic instrument. A portion that corresponds to the volume control knob is pressed, and a portion that corresponds to the tone control knob is also pressed (slid) so as to slide the tone control knob upwards. The tone control knob is supposed to slide upwards on the display screen (the tone also changes) as a consequence. However, as shown in FIG. 11B, in this case, the portion that corresponds to the volume control knob is pressed across five output resistive films Ro1 to Ro5 of the matrix touch panel device. Accordingly, even if any of the five crossings Pa to Pe of the input resistive film Ri1 that corresponds to the portion of the tone control knob and five output resistive films Roa to Roe is pressed, the pressing force will not be detected because of the dead zone phenomenon. Accordingly, the tone control knob moves upwards, so as to jump across the region of the output resistive films Ro1 to Ro5 (the tone changes sharply). The relative positional relationship of the crossings being pressed in FIGS. 9B and 11B are the same. In the matrix resistive film type touch panel, the length of resistive films changes depending on the absolute position of the crossings, resulting in a difference in the output voltage. Whether the clamping phenomenon occurs and whether the dead zone phenomenon occurs depend on which region in the touch panel the crossing being pressed is placed in FIGS. 9B and 11B, and on the setting of the reference voltage.

In view of the above-described problems, it is an object of the present invention to provide a matrix touch panel device that prevents misdetection of a crossing as being pressed, when the crossing is not actually pressed.

### Means to Solve the Problems

A matrix touch panel device according to the present invention includes a plurality of input resistive films formed on a first substrate and respectively having a pair of input terminals at both ends, and a plurality of output resistive films formed on a second substrate placed face to face with the first substrate, intersecting with the plurality of input resistive films in a matrix with a gap therebetween, and detecting whether any of the input resistive films and any of the output resistive films are in contact with each other at a crossing of the input and output resistive films, detects that the first substrate is relatively pressed against the second substrate at the crossing. The matrix touch panel device includes a voltage applying unit that, with respect to each of the input resistive films, selectively applies voltage for detecting contact from either one of the pair of input terminals, a voltage acquiring unit that selectively acquires an output voltage value from each of the output resistive films, from either one of the pair of output terminals, and a determining unit, for each crossing, based on the acquired output voltage value, determines whether the output is attributed to a contact state.

Another matrix touch panel device according to the present invention includes a plurality of input resistive films formed on a first substrate, and a plurality of output resistive films formed on a second substrate placed face to face with the first substrate and intersecting with the plurality of input resistive films in a matrix with a gap therebetween, and by detecting whether any of the input resistive films and any of the output resistive films are in contact with each other at a crossing of the input and output resistive films, detects that the first substrate is relatively pressed against the second substrate at the crossing. The matrix touch panel device includes a voltage applying unit that applies voltage for detecting contact to each of the input resistive films, a voltage acquiring unit that acquires an output voltage value from each of the output resistive films, and a determining unit that, for each crossing, determines whether the output is attributed to a contact state, by comparing the acquired output voltage value and a contact voltage value output when the crossing is in the contact state.

A still another matrix touch panel device according to the present invention includes a plurality of input resistive films formed on a first substrate, and a plurality of output resistive films formed on a second substrate placed face to face with the first substrate and intersecting with the plurality of input resistive films in a matrix with a gap therebetween, and by detecting whether any of the input resistive films and any of the output resistive films are in contact with each other at a crossing of the input and output resistive films, detects that the first substrate is relatively pressed against the second substrate at the crossing. The matrix touch panel device includes a voltage applying unit that applies voltage for detecting contact to each of the input resistive films, a voltage acquiring unit that acquires an output voltage value from each of the output resistive films, an output detecting unit that, for each crossing, based on the acquired output voltage value, detects an output, an extracting unit that, among a plurality of the crossings at which output ON is detected at the same time by the output detecting unit, extracts a non-contact candidate point group that includes one crossing possibly not in a contact state, and a determining unit that, with each of the crossings of the extracted non-contact candidate point group, determines whether the output is attributed to the contact state, and the extracting unit extracts the non-contact candidate point group positioned to form at least one output alternative path that allows output at one crossing even if one of the crosses is not in the contact state because the other crossings are respectively in the contact state.

In the above-described matrix touch panel device, the extracting unit extracts four crossings of two of the input resistive films and two of the output resistive films that are positioned to form the output alternative path.

The above-described matrix touch panel device further includes a calculating unit that, for each of the crossings of the non-contact candidate point group, calculates a false output voltage value output via the output alternative path, and the determining unit, for each of the crossings of the non-contact candidate point group, makes determination by comparing the output voltage value and the false output voltage value.

In the above-described matrix touch panel device, the determining unit, for each of the crossings, makes determination by comparing the output voltage value and the false output voltage value, and also by comparing the output voltage value and a contact voltage value output when the crossing is in the contact state.

In the above-described matrix touch panel device, an output terminal of each of the output resistive films is in a non-grounded state except when the output resistive film receives an output, the matrix touch panel device further includes a switching unit that, when the output of each of the output resistive films is received, switches the output terminal of the output resistive film from the non-grounded state to an output resistance being grounded.

In the above-described matrix touch panel device, at least one of the first and the second substrate is covered by a conductive shield member.

The following configurations may also be used.

A matrix touch panel device according to the present invention includes a plurality of input resistive films formed on a first substrate, and a plurality of output resistive films formed on a second substrate placed face to face with the first substrate and intersecting with the plurality of input resistive films in a matrix with a gap therebetween, and by detecting whether any of the input resistive films and any of the output resistive films are in contact with each other at a crossing of the input and output resistive films, detects that the first substrate is relatively pressed against the second substrate at the crossing. The matrix touch panel device includes a voltage applying unit that applies voltage for detecting contact to each of the input resistive films, a voltage acquiring unit that acquires an output voltage value from each of the output resistive films, and a determining unit, for each crossing, based on the acquired output voltage value, determines whether the output is attributed to a contact state.

With this configuration, if there is a crossing at which an output is detected although the crossing is not actually being pressed, the determining unit determines that the output is not produced by being in a contact state. In other words, the output is determined to be a false output. Accordingly, it is possible to prevent misdetection of a crossing as being pressed, when the crossing is not actually pressed.

In this case, it is preferable that each of the plurality of input resistive films has a pair of input terminals at both ends, and the voltage applying unit, with respect to each of the input resistive films, selectively applies voltage for detecting pressing force at the pair of input terminals. It is also preferable that each of the plurality of output resistive films has a pair of output terminals at both ends, and the voltage acquiring unit selectively acquires the output voltage value from each of the output resistive films at the pair of output terminals.

With this configuration, when each of the plurality of input resistive films has the pair of input terminals at both ends, two input paths of a voltage for detecting contact are formed for each crossing. Because the output voltage value differs depending on the path length, two output voltage values are acquired for each crossing. Accordingly, it is possible to increase the number of output voltage values that can be used for the determination, thereby enabling to make appropriate determination.

The same can be applied when each of the plurality of output resistive films has the pair of output terminals at both ends.

It is further preferable that each of the plurality of input resistive films has the pair of input terminals at both ends, and each of the plurality of output resistive films has the pair of output terminals at both ends. In this case, four (2×2) output voltage values can be acquired. Accordingly, it is possible to further increase the number of output voltage values that can be used for the determination, thereby enabling to make more appropriate determination.

In this case, it is preferable that the determining unit, for each crossing, makes determination by comparing the output voltage value and a contact voltage value output when the crossing is in a contact state.

With this configuration, by comparison with the contact voltage value, it is possible to make accurate determination.

In this case, it is preferable to further include an output detecting unit that, for each crossing, detects an output, and the determining unit makes determination only for the crossings at which output ON is detected.

With this configuration, the number of crossings to be determined is reduced. In other words, the determination is made only for those crossings possibly producing a false output even though the crossings are not in a contact state. Accordingly, it is possible to reduce the time required for a determination process.

In this case, it is preferable to further include an extracting unit that, among a plurality of the crossings at which output ON is detected at the same time, extracts a non-contact candidate point group that includes one crossing possibly not in a contact state. It is also preferable that the extracting unit extracts the non-contact candidate point group positioned to form at least one output alternative path that allows output at one crossing even if one of the crossings is not in the contact state because the other crossings are respectively in the contact state. It is also preferable that the determining unit makes determination only for the crossings of the extracted non-contact candidate point group.

By extracting the non-contact candidate point group positioned to form the output alternative path as the crossings possibly producing a false output, the number of crossings to be determined is further reduced. Accordingly, it is possible to further reduce the time required for the determination process.

In this case, it is preferable that the extracting unit extracts four crossings of two of the input resistive films and two of the output resistive films that are positioned to form the output alternative path.

With this configuration, it is possible to easily perform an extraction process of the non-contact candidate point group.

In this case, it is preferable to further include a calculating unit that, for each of the crossings of the non-contact candidate point group, calculates a false output voltage value (output at the ghost phenomenon: ghost output voltage) output via the output alternative path. It is also preferable that the determining unit, for each of the crossings of the non-contact candidate point group, makes determination by comparing the output voltage value and the false output voltage value.

With this configuration, by comparison with the false output voltage value, it is possible to make accurate determination.

In this case, it is preferable that the determining unit, for each of the crossings, makes determination by comparing the output voltage value and the false output voltage value, and also by comparing the output voltage value and the contact voltage value output when the crossing is in a contact state.

With this configuration, it is possible to makes more accurate determination by comparing the output voltage value with the contact voltage value, as well as with the false output voltage value.

In this case, it is preferable that each of the output resistive films includes an output terminal that is in a non-grounded state except when the output resistive film receives an output. It is also preferable to further include a switching unit that, when the output of each of the output resistive films is received, switches the connection of the output terminal of the output resistive film from the non-grounded state to an output resistance being grounded.

With this configuration, the dead zone phenomenon does not occur unlike in related art, because the output terminal of each of the output resistive films is in the non-grounded state (high impedance) except when the output resistive film receives an output.

In this case, it is preferable that at least one of the upper surface or the lower surface of the touch panel is covered by a conductive shield member.

With this configuration, it is possible to prevent misdetection because the effect of noise from outside is reduced.

It is preferable that the conductive shield member is formed by a transparent resistive film when the touch panel is used in combination with a display device. It is also preferable that the conductive shield member is grounded.

### BRIEF DESCRIPTION OF THE DRAWINGS

FIG. 1 is a structural diagram of a matrix touch panel device according to an embodiment of the present invention.

FIG. 2 is a schematic of a circuit configuration of the matrix touch panel device according to the embodiment of the present invention.

FIG. 3 is a flowchart explaining a pressing force detection process in the matrix touch panel device according to the embodiment of the present invention.

FIG. 4 shows a schematic example of a detection result of an output in the pressing force detection process.

FIGS. 5A to 5D are schematics for explaining four input/output paths in the matrix touch panel device according to the embodiment of the present invention.

FIG. 6 shows a schematic example in which a plurality of output alternative paths are formed with respect to one crossing, in the matrix touch panel device according to the embodiment of the present invention.

FIG. 7 is a schematic for explaining a ghost phenomenon in the matrix touch panel device according to related art.

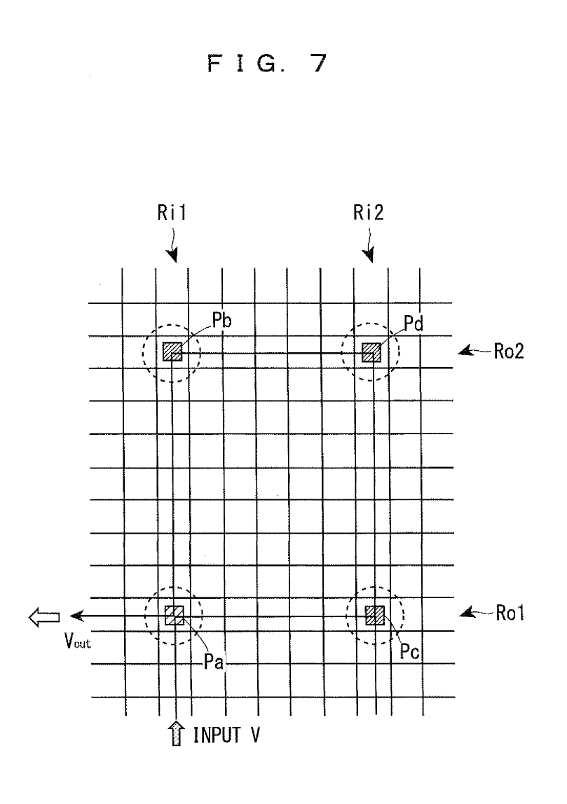

FIGS. 8A and 8B show a specific example of a problem caused by the ghost phenomenon in a device in which the matrix touch panel device according to the related art is applied as a matrix touch panel integrated type display device.

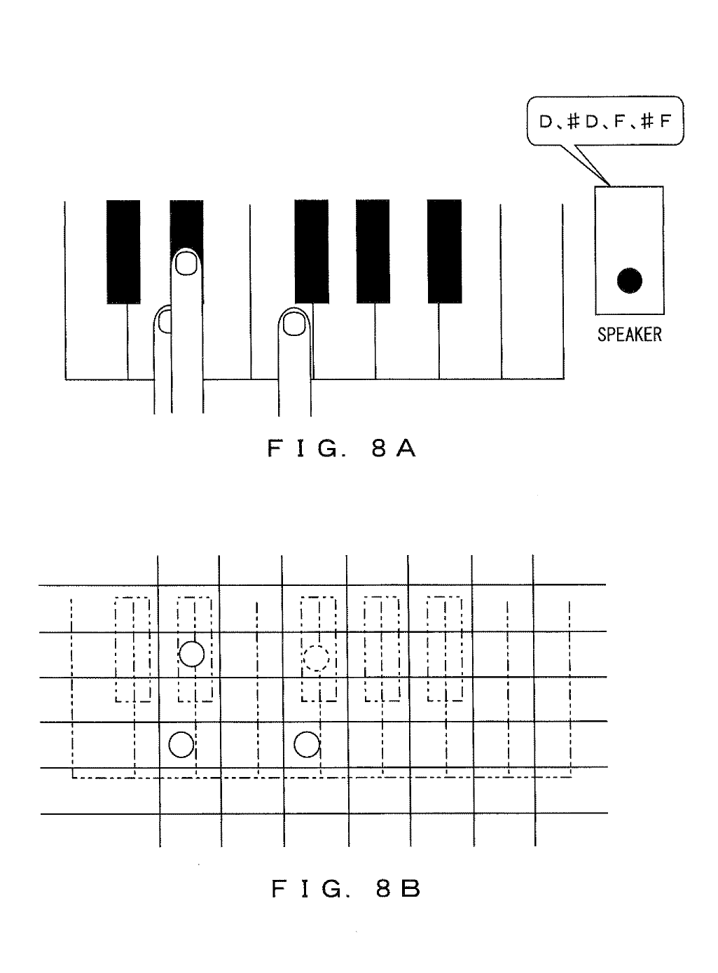

FIG. 9A shows a specific example of a problem caused by a clamping phenomenon, which is one of ghost phenomena, in the device in which the matrix touch panel device according to related art is applied as the matrix touch panel integrated type display device. FIG. 9B shows a specific example of the clamping phenomenon, which is one of ghost phenomena, in the matrix touch panel device according to related art.

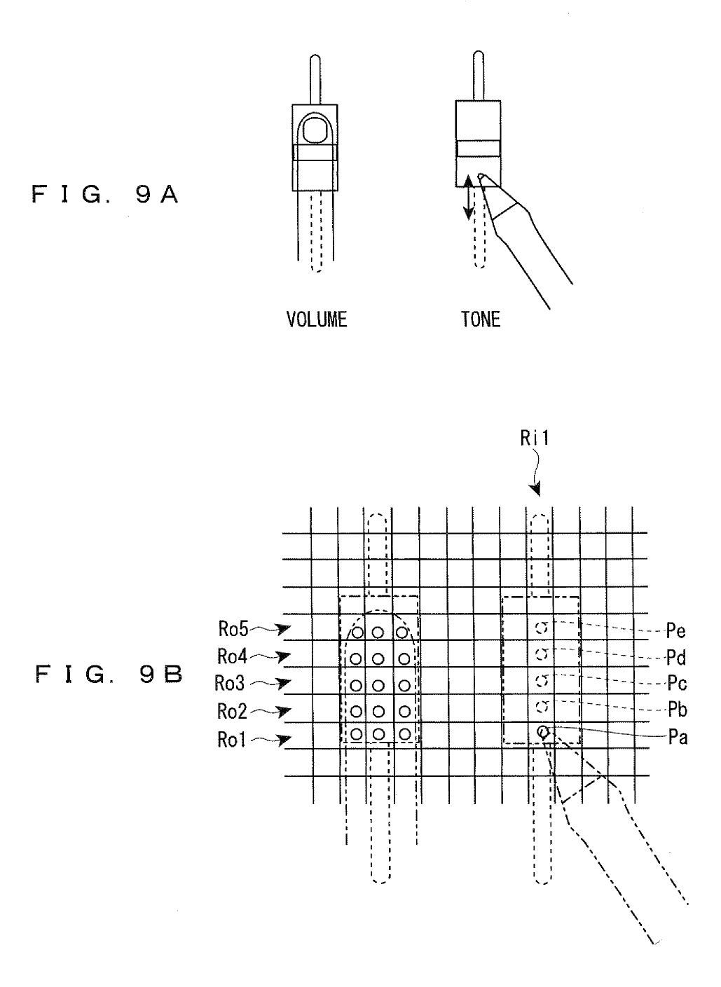

FIG. 10 is a schematic for explaining a dead zone phenomenon in the matrix touch panel device according to the related art.

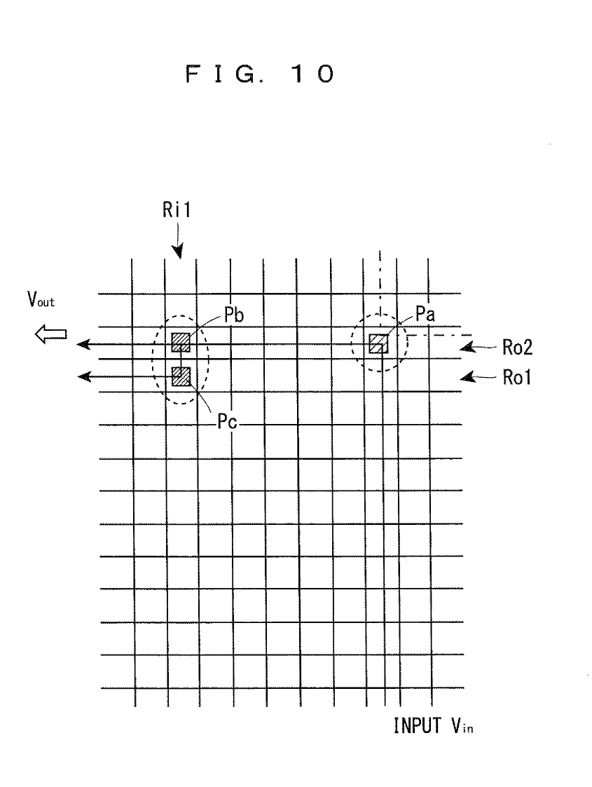

FIG. 11A is a specific example of a problem caused by the dead zone phenomenon in the device in which the matrix touch panel device according to related art is applied as the matrix touch panel integrated type display device. FIG. 11B is a specific example of the dead zone phenomenon in the matrix touch panel device according to related art.

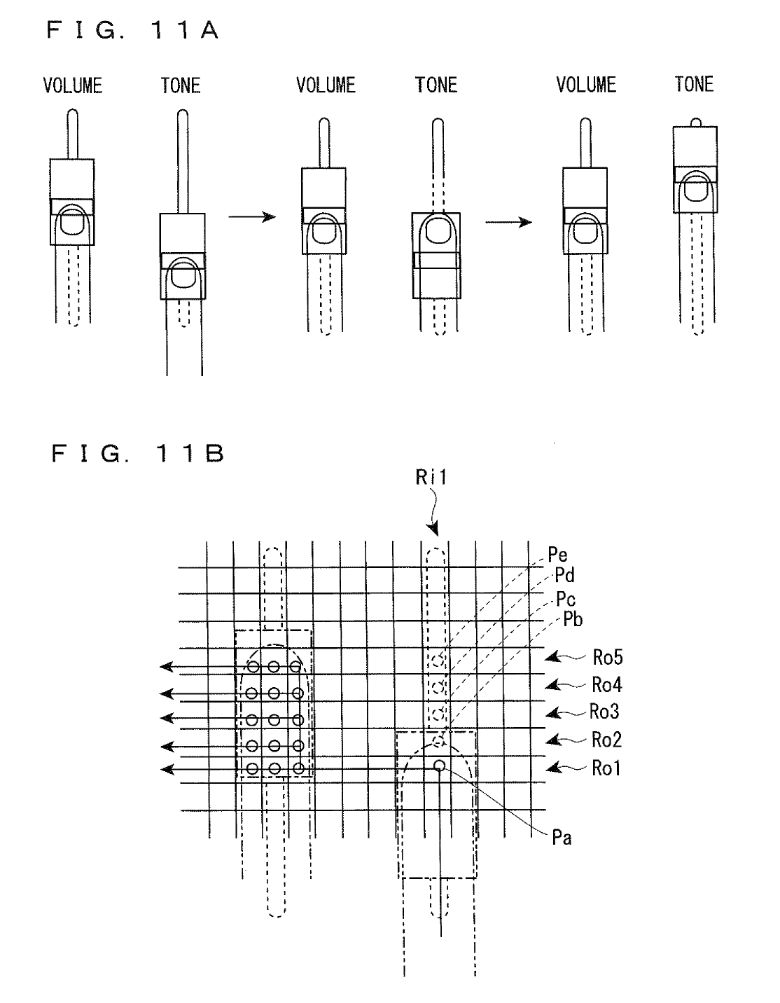

### REFERENCE NUMERALS

10 touch panel
11 first substrate
13 input terminal
14 conductive shield film
21 second substrate
23 output terminal
31 voltage applying unit
32 switching unit
33 AD converter
34 comparator
35 CPU
P cross
Ri input resistive film
Ro output resistive film

### BEST MODE FOR CARRYING OUT THE INVENTION

An exemplary embodiment of the present invention will be described in detail below with reference to the accompanying drawings. A matrix touch panel device (may be simply referred to as “touch panel”) according to the present embodiment, for example, is used by being placed on a display screen of a liquid crystal display device (touch panel integrated type display device). When a user presses a detection surface (upper surface) with a finger and the like, the matrix touch panel device detects the pressing force. The touch panel integrated type display device performs, based on the detection of the pressing force, change of an image on the display screen, output of sound and the like.

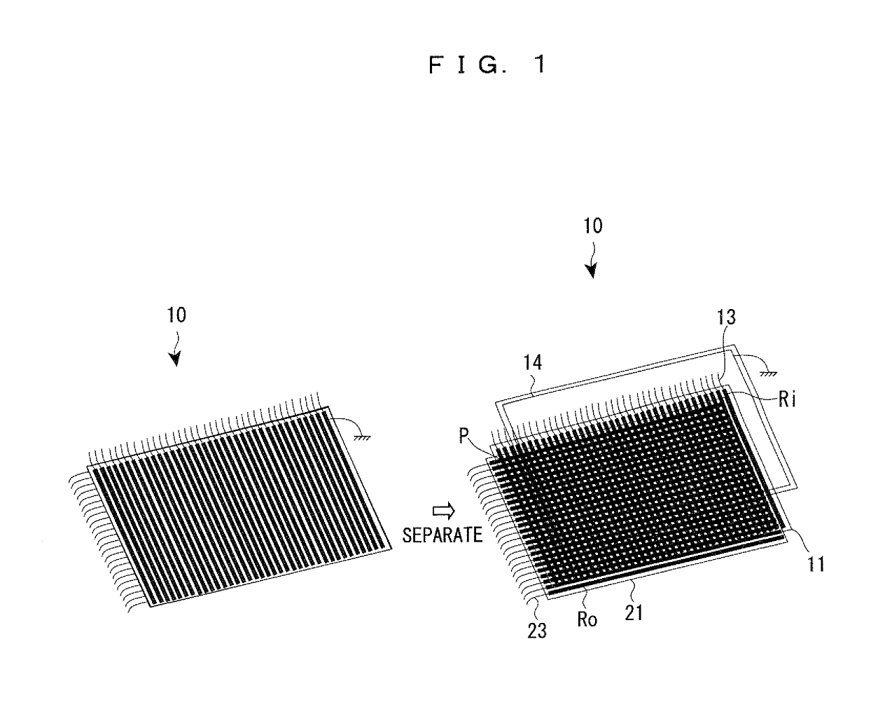

As shown in FIG. 1, a touch panel 10 includes a first substrate 11 that a plurality of input resistive films Ri are formed on the lower surface, and a second substrate 21 placed face to face with the first substrate 11 and that a plurality of output resistive films Ro are formed on the upper surface. The first substrate 11 and the second substrate 21 are overlapped with each other interposing a dot spacer (not shown) therebetween. The plurality of input resistive films Ri is formed on the lower surface of the first substrate 11, and similarly, the plurality of output resistive films Ro is formed on the upper surface of the second substrate 21. The plurality of input resistive films Ri and the plurality of output resistive films Ro form a plurality of crossings P arranged in a matrix in plan view, with a gap in a vertical direction.

The first substrate 11 is made of a flexible transparent film. The second substrate 21 is made of a glass plate. Both the plurality of input resistive films Ri and the plurality of output resistive films Ro are made of a transparent resistive film (such as ITO). At both ends of each input resistive film Ri, an input terminal 13 is provided (only one side is shown in FIG. 1). Similarly, at both ends of each output resistive film Ro, an output terminal 23 is provided (only one side is shown in FIG. 1).

The touch panel 10 is mounted on the display screen, which is not shown, placing the second substrate 21 at the lower side. If a user presses the first substrate 11 against the second substrate 21 from above, with respect to each crossing P, each input resistive film Ri and each output resistive film Ro come in contact with each other at the crossing P. Accordingly, a voltage for detecting contact applied to the input resistive film Ri is output from the output resistive film Ro. Based on the output, whether the first substrate 11 is pressed will be detected.

On the upper surface of the first substrate, a conductive shield film 14 is provided. The conductive shield film 14 is made of a transparent resistive film, and is grounded. The conductive shield film 14 is constantly insulated from the input resistive film Ri by the substrate 11. The conductive shield film 14 reduces the effect of noise from outside, thereby preventing misdetection. Considering the effect of noise from below (particularly, display device), it is preferable to provide a conductive shield film on the lower surface of the second substrate 21. However, taking into account viewability of the display screen, it is preferable to keep the number of conductive shield films to the required minimum.

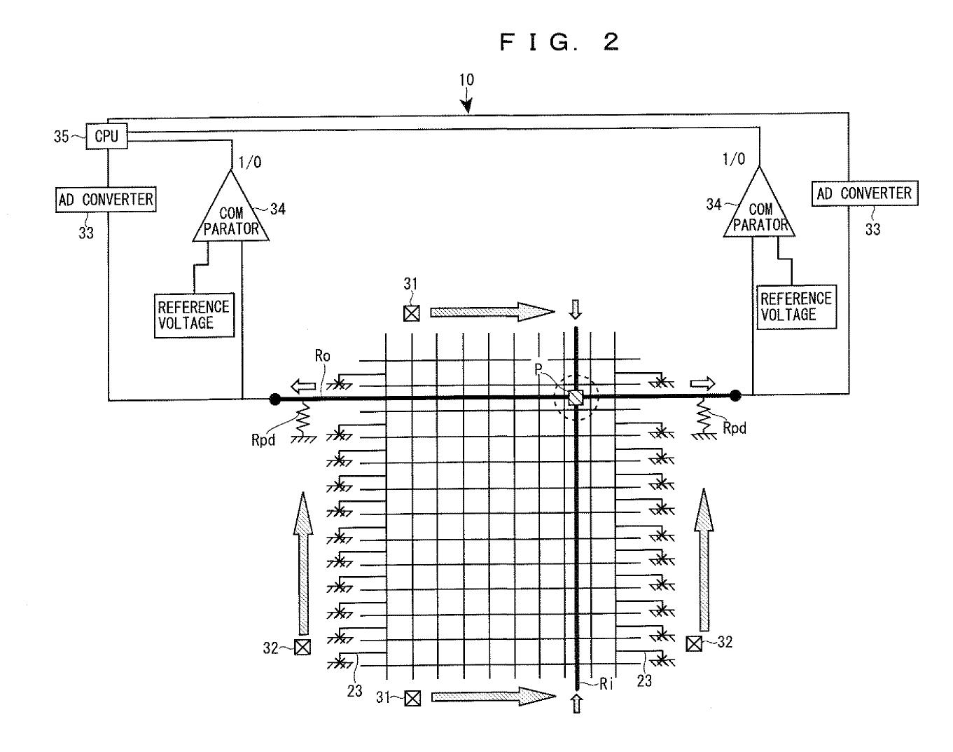

As shown in FIG. 2, the touch panel 10 includes a voltage applying unit 31, a switching unit 32, an AD converter 33, a comparator 34, and a CPU 35. There are two voltage applying units 31 because the input terminal 13 (not shown in FIG. 2) is respectively provided at the both ends of each input resistive film Ri. Similarly, there are two switching units 32, two AD converters 33, and two comparators 34, because the output terminal 23 is respectively provided at the both ends of each output resistive film Ro.

Each voltage applying unit 31 sequentially applies voltage (input sweep) for detecting pressing force with respect to the plurality of input resistive films Ri, one by one from the end. Each switching unit 32 is formed of a switching element such as an IC, and with the plurality of output resistive films Ro, the switching unit 32 switches the connection of each output terminal 23 from a non-grounded state (high impedance) to the output resistance being grounded, and receives output voltage (output scan). In other words, each output terminal 23 is in the non-grounded state to prevent the occurrence of the dead zone phenomenon in related art, except when each output resistive film receives an output. However, by each switching unit 32, each output terminal 23 is grounded via an output resistance Rpd, on receiving an output. When each input resistive film Ri and each output resistive film Re are in contact with each other at each crossing P, a voltage is output from the output resistive film Ro.

After performing a sequential output scan on the plurality of output resistive films Ro, while the voltage for detecting pressing force is applied to one input resistive film Ri, a voltage is applied to the adjacent input resistive film Ri, and the output scan will be performed similarly. By repeating this, the output voltages of the entire crossings P are received.

Because the input terminal 13 is provided at the both ends of each input resistive film Ri, it is possible to selectively apply voltage to the both ends of each input resistive film Ri, by each voltage applying unit 31. Similarly, because the output terminal 23 is respectively provided at the both ends of each output resistive film Ro, it is possible to selectively output voltage from the both ends of each output resistive film Ro, by each switching unit 32. Accordingly, for each crossing P, four input/output paths of voltage for detecting pressing force (in the drawing, bottom input/left output, top input/left output, bottom input/right output, top input/right output). Because an output voltage value differs by the path length (length of resistive film), four output voltage values can be acquired for each crossing P (details will be described later).

Each AD converter 33 (voltage acquiring unit) acquires an output voltage value (such as 10 bits) by AD converting the output voltage received from each output resistive film Ro, and outputs to the CPU 35.

Each comparator 34 compares the output voltage received from each output resistive film Ro and a reference voltage, and digitally outputs the result to the CPU 35. The CPU 35, based on the output result, detects an output for each crossing P. A “detecting unit” in the appended claims is mainly formed by the comparator 34 and the CPU 35. The CPU 35 also executes various types of arithmetic processes and determination processes. A determining unit, an extracting unit, and a calculating unit in the appended claims are mainly formed by the CPU 35.

Even with the touch panel 10 formed in this manner, similar to the matrix touch panel described in related art, if three crossings P at three points orthogonal to one another are pressed at the same time, an output is also produced from the output resistive film Ro, at the crossing P which is not actually pressed (input resistive film Ri and output resistive film Ro are in non-contact state) (ghost phenomenon). Therefore, in the touch panel 10 according to the present embodiment, the following pressing force detection process is carried out to prevent misdetection of a crossing P as being in contact, when an output is produced at the crossing P in a non-contact state.

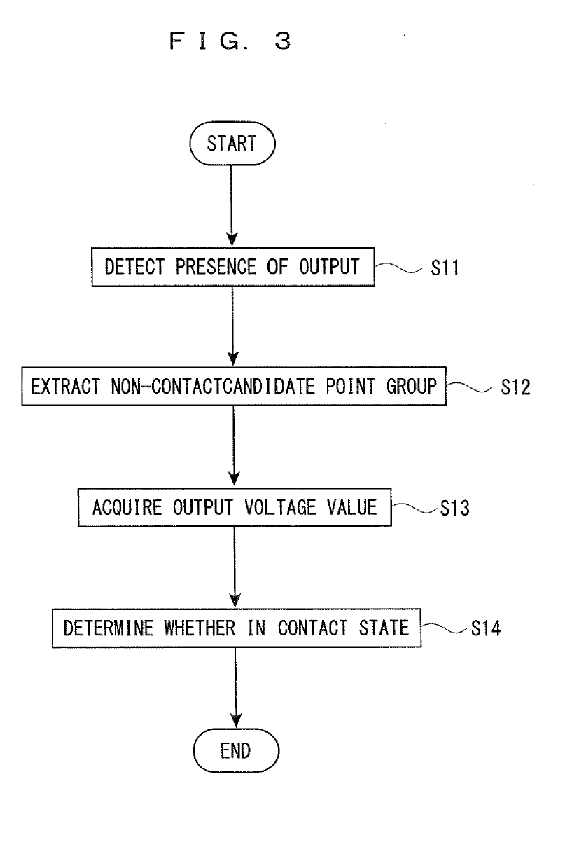

FIG. 3 is a series of flows of pressing force detection process. The CPU 35, based on the digital output result from the comparator 34, respectively detects an output of the entire crossings P (S11). The reference voltage of the comparator 34 is set to a value in which the output ON is detected even when each crossing is in a non-contact state (normally, voltage value lower than the contact state is output). As described above, there are four input/output paths so as to acquire four output voltage values for each crossing P. However, because whether the output is ON or OFF is to be detected here, only one input/output path is needed. However, the length of a resistive film at the time of pressing force varies depending on where the crossing P is positioned at the touch panel, thereby varying the output voltage value. Accordingly, an output may also be detected by using an appropriate input/output path, so as the difference with the reference voltage of the comparator 34 becomes as large as possible, in other words, so as noise and the like is less likely to be received.

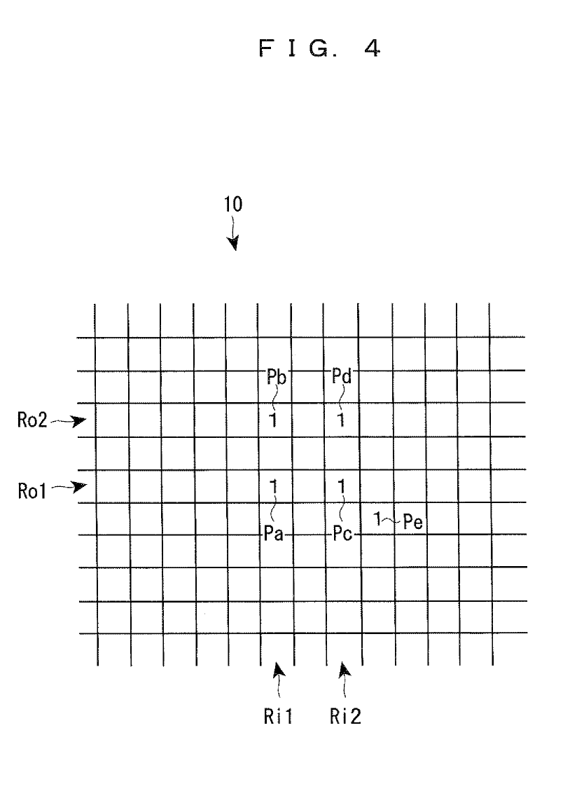

FIG. 4 is a schematic example of a detection result of an output. Here, although a crossing Pa is actually in a non-contact state, five crossings Pa to Pe including the crossing Pa are detected as output ON (referred to as “1” in FIG. 4). With the remaining crossings P, the output is OFF (blanks in FIG. 4).

Next, the CPU 35 extracts a non-contact candidate point group including a crossing possibly not in a contact state, from the five crossings Pa to Pe of which output ON is detected at the same time. In other words, with the non-contact candidate point group, because the other crossings are respectively in a contact state, crossings positioned to form an output alternative path that allows the crossing P to output are extracted even if one of the crossings P is not in a contact state.

More specifically, the CPU 35 extracts four crossings P of two input resistive films Ri and two output resistive films Ro, positioned to form an output alternative path. In other words, with each input resistive film Ri, the CPU 35 sequentially checks whether there are crossings P with output ON equal to or more than two. Here, two crossings Pa and Pb with output ON are present on an input resistive film Ri1. At this time, it is recognized that the crossing Pa is on an output resistive film Ro1, and the crossing Pb is on an output resistive film Ro2. Subsequently, the CPU 35 checks whether a crossing P with output ON is present on the output resistive film Ro1 or on the output resistive film Ro2, on the other input resistive film Ri. Here, a crossing Pc with output ON is present on the output resistive film Ro1, on an input resistive film Ri2. If so, even if the crossing Pd between the input resistive film Ri2 and the output resistive film Ro2 is not in a contact state, output ON should be detected by the ghost phenomenon. Then, output ON is actually confirmed at the crossing Pd. In this manner, among five crossings Pa to Pe that output ON are detected, the four crossings Pa to Pd are recognized to be positioned to form an output alternative path. In other words, the four crossings Pa to Pd are extracted as the non-contact candidate point group including a crossing P possibly not actually being pressed.

Next, the AD converter 33 acquires an AD converted output voltage value for the respective crossings Pa to Pd of the extracted non-contact candidate point group (S13). In other words, as described above, four output voltage values are acquired from four input/output paths. The CPU 35 then determines whether the respective four crossings Pa to Pd are in a contact state (S14). In other words, with each input/output path, a calculated contact voltage value stored in advance (or calculated on a trial basis) and the AD converted output voltage value are compared, and if the output voltage value is significantly smaller than the contact voltage value (output voltage value<contact voltage value−δ, δ: maximum measurement error value), it is judged that the output is not produced by being in a contact state. Details will now be explained.

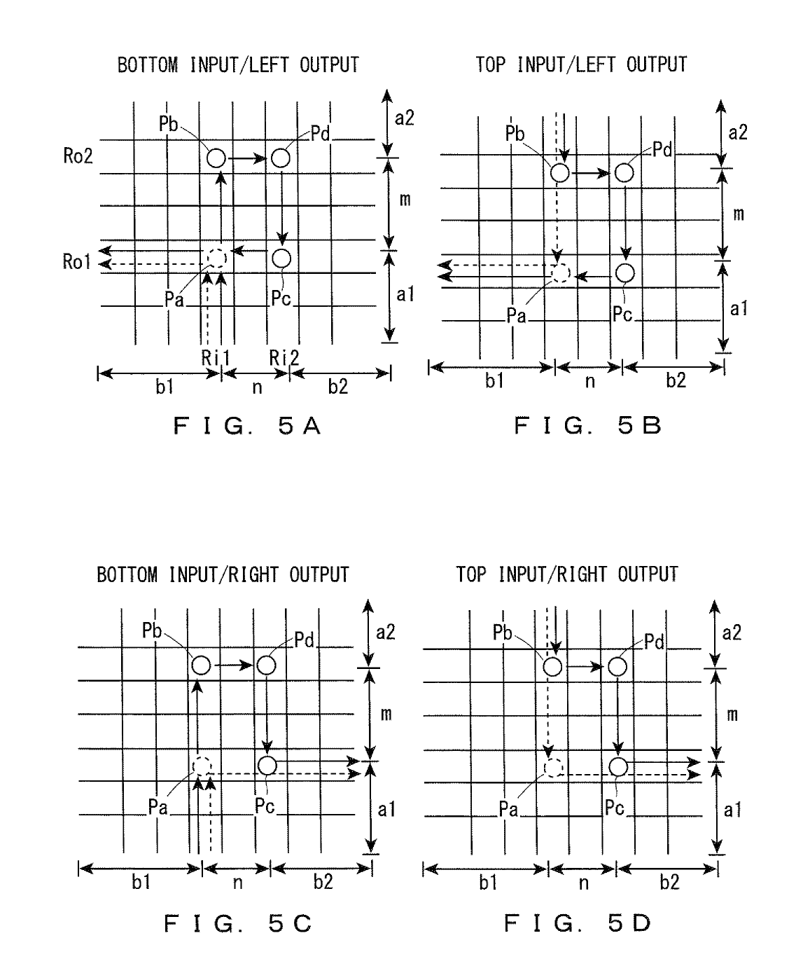

FIG. 5 is schematics of output alternative paths in the respective input/output paths, for a crossing Pa in a non-contact state. Assume there is only one input/output path of “bottom input/left output” (see FIG. 5A). In this case, depending on where the crossing Pa is positioned in the entire touch panel 10, there is a possibility of only acquiring an output voltage value having a small difference from the contact voltage value. In other words, if the crossing Pa is positioned at the lower left of the entire touch panel 10, a normal path length of “a1+b1” is not so large a value. Accordingly, by the path difference of “2m+2n”, it is possible to acquire an output voltage value having a large difference from the contact voltage value. However, if the crossing Pa is positioned at the upper right of the entire touch panel 10, the normal path length of “a1+b1” becomes a significantly large value. Accordingly, it is only possible to acquire an output voltage value having a small difference from the contact voltage value. In this case, whether the crossing Pa is in a contact state may not be appropriately determined.

With respect to this problem, in the touch panel 10 according to the present embodiment, four output voltage values can be acquired with four input/output paths. Accordingly, irrespective of where the crossing Pa is positioned in the entire touch panel 10, an output voltage value having a large difference from the contact voltage value can be acquired at least at one input/output path. More specifically, even if the crossing Pa is positioned at the upper right in the entire touch panel 10, with the input/output path of “top input/left output” (see FIG. 5B), because the normal path of “a2+b1” is not so large, an output voltage value having a large difference from the contact voltage value can be acquired, by the path difference of “2n”. In other words, as described above, with each input/output path, the calculated contact voltage value stored in advance and the acquired output voltage value are compared. Accordingly, with the crossing Pa in the non-contact state, it is possible to appropriately determine that the output voltage value is significantly smaller than the contact voltage value, by at least one of the input/output paths.

Similarly, the same can be said for where the crossing P actually in a non-contact state is positioned in the four crossings P, extracted as crossings that might not be pressed. In other words, as described above, even if the “bottom input/left output” is the only input/output path, if the crossing Pa is in a non-contact state, the output alternative path is long with “2m+2n”. Accordingly, it is possible to acquire an output voltage value having a large difference from the contact voltage value. However, if the crossing Pd is in a non-contact state, the output alternative path is the shortest of “m+n” (corresponds to “top input/right output” in FIG. 5 D at crossing Pa), it is only possible to acquire the output voltage value having the smallest difference from the contact voltage value.

With respect to this problem, in the touch panel 10 according to the present embodiment, because four output voltage values can be acquired by four input/output paths, irrespective of where the crossing P actually in a non-contact state is positioned at either of the extracted four crossings P, it is possible to acquire an output voltage value having a large difference from the contact voltage value, at least in one input/output path. More specifically, even if the crossing Pd is in a non-contact state, with the input/output path of the “top input/right output”, the output alternative path is long with “2m+2n” (corresponds to “bottom input/left output” in FIG. 5A at crossing Pa), thus it is possible to acquire an output voltage value having a large difference from the contact voltage value.

In this manner, because four output voltage values can be acquired by four input/output paths, it is possible to determine whether each crossing P is in a contact state, by using four output voltage values. Accordingly, it is possible to make appropriate determination.

In the present embodiment, as a crossing P possibly producing a false output, the non-contact candidate point group positioned to form the output alternative path is extracted, before acquiring the output voltage value. Accordingly, the number of the crossings P to be determined is reduced. Accordingly, it is possible to reduce the time required for the determination process.

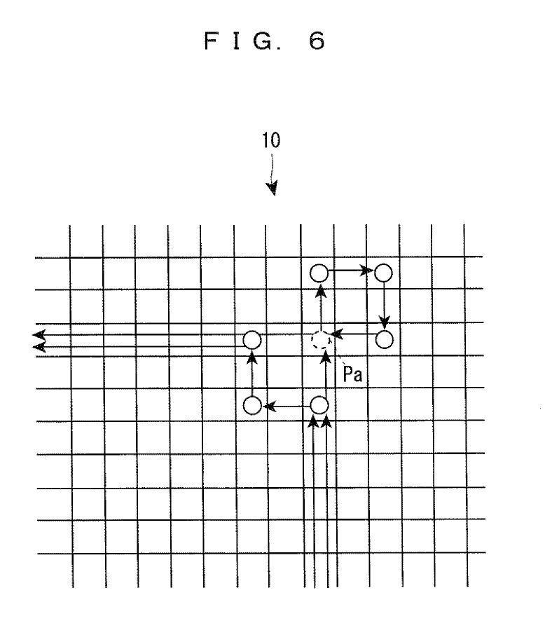

Further, in the present embodiment, the output voltage value and the contact voltage value are compared. However, the CPU 35 may also calculate a false output voltage value being output via the output alternative path for each crossing P, and compare the calculated false output voltage value with the acquired output voltage value. The determination may be carried out more accurately, if the comparison is made against the contact voltage value as well as the false output voltage value. As shown in FIG. 6, a plurality of output alternative paths may be formed for one crossing Pa. In this case, the CPU 35 calculates the false output voltage value being output via the plurality of output alternative paths or the contact voltage value, and uses them for the determination.

As described above, with the touch panel 10 according to the present embodiment, it is possible to prevent misdetection of a crossing P as being pressed, when the crossing P is not actually pressed. The touch panel 10 may be applied to DJ equipments (such as player and mixer), electronic instruments, MIDI controllers, game machines, touch panel PCs, PDAs (personal digital assistants), mobile phones, bank ATMs, and the like.

Particularly, with the touch panel 10 according to the present embodiment, even if three or more points are pressed at the same time, the ghost phenomenon, the clamping phenomenon, and the dead zone phenomenon do not occur, thereby assuring the detection result at the pressed position. Therefore, it is most effective when applied to a device whose efficiency is improved by being operated by a plurality of fingers at the same time, or a device whose convenience is improved by being operated by a plurality of users at the same time.

1-11. (canceled)

12. A matrix touch panel device that includes a plurality of input resistive films formed on a first substrate and respectively having a pair of input terminals at both ends, and a plurality of output resistive films formed on a second substrate placed face to face with the first substrate, intersecting with the plurality of input resistive films in a matrix with a gap therebetween, and respectively having a pair of output terminals at both ends, and by detecting whether any of the input resistive films and any of the output resistive films are in contact with each other at a crossing of the input and output resistive films, detects that the first substrate is relatively pressed against the second substrate at the crossing, the matrix touch panel device comprising:
a voltage applying unit that, with respect to each of the input resistive films, selectively applies voltage for detecting contact from either one of the pair of input terminals;
a voltage acquiring unit that selectively acquires an output voltage value from each of the output resistive films, from either one of the pair of output terminals; and
a determining unit that, for the crossing, based on the acquired output voltage value, determines whether the output is attributed to a contact state.

13. A matrix touch panel device that includes a plurality of input resistive films formed on a first substrate, and a plurality of output resistive films formed on a second substrate placed face to face with the first substrate and intersecting with the plurality of input resistive films in a matrix with a gap therebetween, and by detecting whether any of the input resistive films and any of the output resistive films are in contact with each other at a crossing of the input and output resistive films, detects that the first substrate is relatively pressed against the second substrate at the crossing, the matrix touch panel device comprising:
a voltage applying unit that applies voltage for detecting contact to each of the input resistive films;
a voltage acquiring unit that acquires an output voltage value from each of the output resistive films; and
a determining unit that, for the crossing, determines whether the output is attributed to a contact state, by comparing the acquired output voltage value and a contact voltage value output when the crossing is in the contact state.

14. A matrix touch panel device that includes a plurality of input resistive films formed on a first substrate, and a plurality of output resistive films formed on a second substrate placed face to face with the first substrate and intersecting with the plurality of input resistive films in a matrix with a gap therebetween, and by detecting whether any of the input resistive films and any of the output resistive films are in contact with each other at a crossing of the input and output resistive films, detects that the first substrate is relatively pressed against the second substrate at the crossing, the matrix touch panel device comprising:
a voltage applying unit that applies voltage for detecting contact to each of the input resistive films;
a voltage acquiring unit that acquires an output voltage value from each of the output resistive films;
an output detecting unit that, for the crossing, based on the acquired output voltage value, detects an output;
an extracting unit that, among a plurality of the crossings at which output ON is detected at the same time by the output detecting unit, extracts a non-contact candidate point group that includes one crossing possibly not in a contact state; and
a determining unit that, with each of the crossings of the extracted non-contact candidate point group, determines whether the output is attributed to the contact state, wherein
the extracting unit extracts the non-contact candidate point group positioned to form at least one output alternative path that allows output at one crossing even if one of the crosses is not in the contact state because the other crossings are respectively in the contact state.

15. The matrix touch panel device according to claim 14, wherein the extracting unit extracts four crossings of two of the input resistive films and two of the output resistive films that are positioned to form the output alternative path.

16. The matrix touch panel device according to claim 14, further comprising:
a calculating unit that, for each of the crossings of the non-contact candidate point group, calculates a false output voltage value output via the output alternative path, wherein
the determining unit, for each of the crossings of the non-contact candidate point group, makes determination by comparing the output voltage value and the false output voltage value.

17. The matrix touch panel device according to claim 12, wherein
each of the output resistive films includes an output terminal that is in a non-grounded state except when the output resistive film receives an output,
the matrix touch panel device further comprising a switching unit that, when the output of each of the output resistive films is received, switches the output terminal of the output resistive film from the non-grounded state to an output resistance being grounded.

18. The matrix touch panel device according to claim 12, wherein at least one of the first and the second substrates is covered by a conductive shield member.
